(19) United States
(12) Patent Application Publication
(10) Pub. No.: US 2009/0314815 A1
(43) Pub. Date: Dec. 24, 2009

(54) REMOVABLE STOWABLE LUGGAGE RACK

(75) Inventor: Craig Stapleton, St. Clair, MI (US)

Correspondence Address: YOUNG BASILE, 3001 WEST BIG BEAVER ROAD, SUITE 624, TROY, MI, 48084, US

(73) Assignee: THE AMERICAN TEAM, Mt. Clemens, MI (US)

(21) Appl. No.: 12/144,921

(22) Filed: Jun. 24, 2008

(51) Int. Cl. B60R 9/045; B60R 9/052; B60R 9/058

(52) U.S. Cl. 224/330; 224/321; 224/331; 224/314

(57) ABSTRACT

An article carrier for attachment to a vehicle includes a first side rail an a second side rail to be located extending generally parallel to one another and spaced laterally from one another with respect to a longitudinal centerline of the vehicle. A first cross-rail and a second cross-rail are independently movable between a stowed position and a deployed position, wherein the stowed position of the first and second cross-rails are axially aligned with a corresponding side rail, and the deployed position of the first and second cross-rail are laterally extending between the first and second side rails. The cross rails can be gas assist, injection molded cross rails. A manually hand/finger rotated fastener attaches each end of the first and second cross-rails to the first and second side rails in the stowed position and the deployed position.

### FIELD OF THE INVENTION

The present invention relates, in general, to vehicle article carriers, such as luggage racks, and, more particularly to a vehicle article carrier having cross rails movable between a stowed position overlaying the vehicle side rails and are article carrying position spanning the side rails.

### BACKGROUND

In order to free up additional space within a vehicle of any particular size, article carriers, such as luggage racks are frequently mounted on the vehicle roof. A typical article carrier includes a pair of spaced side rails generally orientated parallel to the longitudinal axis of the vehicle and typically two cross rails are connected at opposite ends to the side rails and laterally span the vehicle roof between the side rails. The cross rails of this type of article carrier raise the overall height of the vehicle and can create problems when transporting the vehicle, or when the vehicle enters low height openings and buildings or parking structures. Cross rails of this type are susceptible to damage, such as damage caused by automatic car wash equipment. Cross rails of this type can also create audible wind noise which can be heard by occupants of the vehicle. Various article carrier configurations have been devised to address these deficiencies.

### SUMMARY

It would be desirable to provide vehicle article carriers which minimize the deficiencies while at the same time providing a low manufacturing cost, ease of use, and safe load distribution. To overcome the deficiencies of the prior known devices, an article carrier for attachment to a vehicle according to an embodiment of the invention includes a first side and a second side rail to be located extending generally parallel to one another and spaced laterally from one another with respect to a centerline of the vehicle. A first cross-rail and a second cross-rail are separable from the side rails and movable between a stowed position and deployed position. The stowed position of the first and second cross-rails corresponds to a position axially aligned with a corresponding side rail. The deployed position of the first and second cross-rails corresponds to a position laterally extending between the first and second side rails. A manually hand/finger rotated fastener attaches each end of the first and second cross rails to the first and second side rails in the stowed position and the deployed position.

An article carrier for attachment to a vehicle according to an embodiment of the present invention includes a one-piece first side rail and a one-piece second side rail to be located extending generally parallel to one another and spaced laterally from one another with respect to a centerline of the vehicle. A gas-assist, injection molded first cross rail and a gas-assist, injection molded second cross rail are separable from the first and second side rails and movable between a stowed and deployed position. The stowed position of the first and second cross rails corresponds to a position axially with a corresponding side rail. The deployed position of the first and second cross rails corresponds to a position laterally extending between the first and second side rails. A manually hand/finger rotated fastener attaches each end of the first and second cross rails to the first and second side rails in the stowed position and the deployed position. A stanchion is pivotally connected to each end of the first and second cross rails. Each stanchion supports a corresponding one of the manually hand/finger rotated fasteners associated with each end of the cross rails. Each stanchion is pivotal between a high profile mode when the cross-rails are in the deployed position and a low profile mode when the cross-rails are in the stored position.

An article carrier for attachment to a vehicle according to an embodiment of the invention includes a one-piece first side rail and one-piece second side rail to be located extending generally parallel to one another and spaced laterally from one another with respect to a centerline of the vehicle. The first and second side rails are formed of a non-filled, non-abrasive nylon. A gas-assist, injection molded first cross-rail and gas-assist, injection molded second cross-rail are separable from the first and second side rails and movable from the side rails to be relocated between a stowed position and deployed position. The stowed position of the first and second cross-rails corresponds to a position axially aligned with a corresponding side-rail. The deployed position of the first and second cross-rails corresponds to a position laterally extending between the first and second side-rails. Each of the first and second cross-rails has a hollow interior extending longitudinally along at least a portion of the cross-rail. The first and second cross-rails are positionable in any one of a plurality of predetermined fixed locations actually spaced along the first and second rails when in the deployed position. A manually hand/finger rotated fastener attaches each end of the first and second cross-rails to the first and second side rails in the stowed position and the deployed position. A stanchion is connected to each end of the first and second cross-rails. Each stanchion supports a corresponding one of the manually hand/finger rotated fasteners associated with each end of the cross-rails. A pivot joint is located between each stanchion located on opposite ends of the first and second cross-rails and central portion of the corresponding cross-rail. Each pivot joint allows the central portion of the associated cross-rail to pivot between a high profile mode when the cross-rail is in the deployed position and a low profile mode when the cross-rail is in the stowed position.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a plan view of an article carrier for attachment to a vehicle illustrating first and second side rails located extending generally parallel to one another and spaced laterally from one another with respect to a center line of the vehicle and with first and second cross-rails located in a stowed position axially aligned with a corresponding side rail;

FIG. 2 is a plan view of the article carrier of FIG. 1 with the first and second cross-rails moved from the stowed position to a deployed position laterally extending between the first and second side rails with optional deployed positions of the cross-rails shown in phantom;

FIG. 3 is a detailed perspective of said rail attachment to a roof of the vehicle and a side rail cover concealing the attachment;

FIG. 4 is a perspective cross-sectional view of one side rail at an optional cross rail deployed connection point with an embedded precision fastener insert and having a cross-rail in the stowed position and illustrating a gas-assist channel formed in the cross-rail;

FIG. 5 is a detailed perspective view of the cross-rail moved from the stowed position to a deployed position with a manually hand/finger rotated fastener attaching the cross rail to the precision fastener insert embedded with the side rail at the optional position previously shown in phantom in FIG. 2;

FIG. 6 is a cross-sectional perspective view of an end of the cross-rail in the stowed position with respect to the side rail with a manually hand/finger rotated fastener attaching the end of the cross-rail to the side rail;

FIG. 7 is a cross-section view of a side-rail attachment to a roof of the vehicle with the cross-rail in the stowed position and the gas-assist channel formed in the cross-rail;

FIG. 8 is a detailed perspective view of a side rail cover illustrated in FIG. 3;

FIG. 9 is a detailed perspective view of an end of a cross-rail and a stanchion pivotally attached to each end of the cross-rail supporting a manually hand/finger rotated fastener or thumb wheel assembly for attachment of the cross-rail to the side rail in the stowed position and the deployed position;

FIG. 10 is a detailed view of an end of a middle portion of the cross-rail illustrating a gas-assist port formed in the cross-rail;

FIG. 11 is a detailed view of a stanchion as previously illustrated in FIGS. 5, 6, and 9;

FIG. 12 is a cross-sectional perspective view of an end of the cross rail in the stowed position with respect to the side rail with another aspect of a rotatable fastener attaching the end of the cross rail to the side rail; and

FIG. 13 is a cross sectional perspective view of an end of the cross rail in the stowed position with respect to the side rail of yet another aspect of a rotatable fastener attaching the end of the cross rail to the side rail.

### DETAILED DESCRIPTION

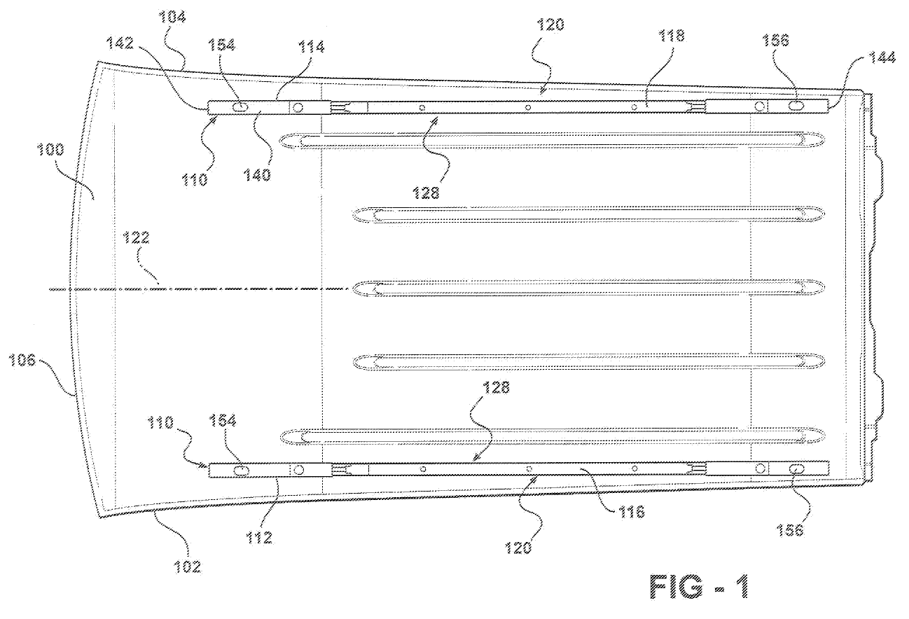

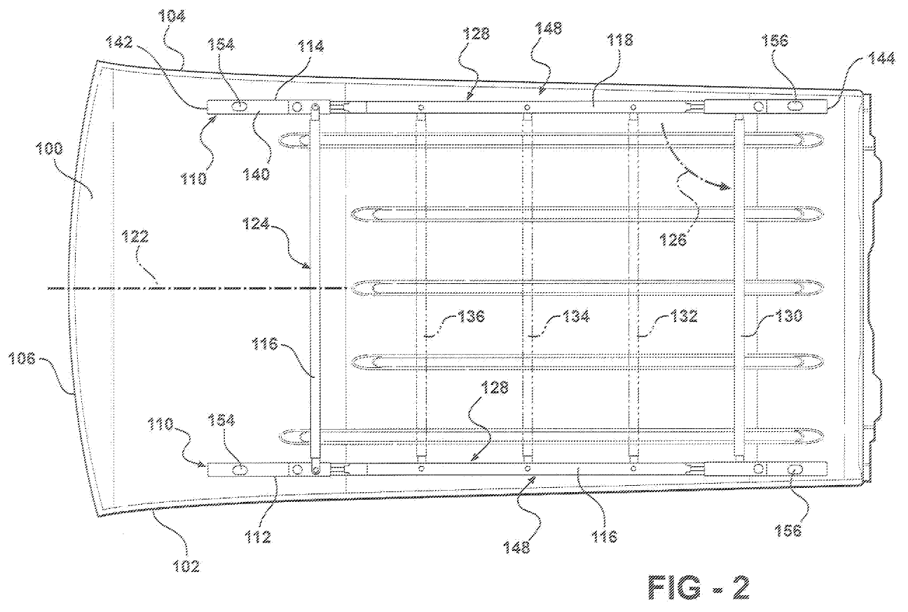

Referring now to FIGS. 1-11, and in particular to FIGS. 1-2, there is depicted a vehicle roof 100 having opposed longitudinally extending sides 102 and 104. Reference number 106 represents the front of the vehicle roof 100.

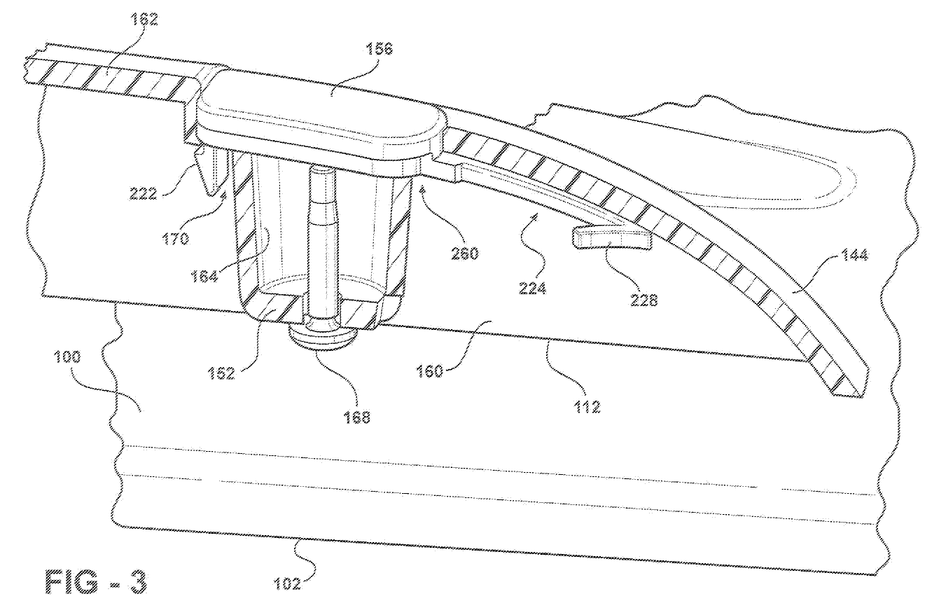

An article carrier 110, also referred to as a luggage rack, is fixedly mounted on the vehicle roof 100. Typically, and by way of example only, the article carrier 110 includes a pair of side rails formed of a first side rail 112 mounted along the driver's side and longitudinal edge 102 of the vehicle roof 100 and a second side rail 114 mounted along the passenger side or second longitudinal edge 104 of the roof 100. As best seen in FIG. 3, fasteners 168 may be wall studs attached to the roof 100 at longitudinally spaced locations along the longitudinal edges 102 and 104. The studs 168 may be threaded to receive a nut or otherwise formed to receive the side rails 112 and 114 in a snap-on, fixed attachment.

The article carrier 110 also includes a first or forward most cross rail 116 and a second or rear cross rail 118.

By way of example, the front cross rail 116 is movable from a first position shown by reference number 120 in which the first cross rail 116 is aligned with a longitudinal axis 122 of the vehicle roof 100 and generally parallel with respect to the longitudinal edge 102 as best seen in FIG. 1. In this first position, also referred to as a “stowed” position, the first cross rail 116 overlays and is substantially aligned in parallel with the first side rail 112. The first cross rail 116, as described in detail hereafter, is moveable or re-locatable to a second position denoted by reference number 124 in which the first cross rail 116 spans the first and second side rails 112 and 114 and is positioned generally perpendicular to the vehicle longitudinal axis 122 at the forward end of the article carrier 110 as best seen in FIG. 2.

The second or rear cross rail 118 is also moveable or re-locatable as shown by the arrow 126 between a first stowed position denoted by reference number 128 in which the second or rear cross rail 118 is disposed substantially parallel to the second longitudinal edge 104 of the vehicle 100 and the longitudinal axis 122 of the roof 100 as best seen in FIG. 1. In this position, as shown in FIG. 1, the rear cross rail 118 overlays and is substantially parallel with the second side rail 114. The rear cross rail 118 is also moveable or relocatable, as described hereafter, to a second position shown in FIG. 2 by reference number 130 in which the rear cross rail 118 spans and is disposed generally perpendicular to the vehicle longitudinal axis 122 and the first and second side rails 112 and 118.

As shown in FIG. 2, the rear cross rail 118 is longitudinally deployable with respect to the vehicle roof and longitudinal axis 122 between a first or rearmost position denoted by reference number 130 to any one of a plurality of successive forward positions 132, 134 and 136, with three such positions 132, 134, and 136 shown only by example in FIG. 2.

As shown in FIGS. 1-8, each of the side rails 112 and 114 is substantially identically constructed such that the following description of the construction of the one side rail 112 or 114 will be understood to apply equally to the construction of the other side rail 114 or 112.

As shown in FIGS. 1 and 2, the side rail 114 includes an elongate body 140 formed of a suitable article carrier material, such as a lightweight plastic, fiberglass, composite, etc. The body 140 extends from a first or foremost end 142 to a second or rearmost end 144. As best seen in FIG. 3, the body 140 includes a fastener-receiving aperture 164 with a lower wall portion 152 extending from the second end 144 to a recessed intermediate portion 148. The recessed intermediate portion 148 extends from the end portion 142 to a rearmost fastener-receiving aperture 164 with a lower wall portion 152 which transitions into the second rear end 144.

As best seen in FIGS. 3 and 8, a pair of solid or hollow first and second covers 154 and 156 are disposable over the fastener-receiving apertures 164 defined by lower walls portions 146 and 152, respectively, of the body 140 to provide a smoothly tapered aerodynamic and aesthetically pleasing shape between the first and second ends 142 and 144 and the recessed portion or surface 148 of the body 140. The covers 154 and 156 are secured to the body 140 by fasteners, adhesive, snap-in connections, etc. As best seen in FIG. 8, the covers 154, 156 can include snap in connections 222, engageable with the notch 170 best seen in FIG. 3,and retention connections 224 for retaining the covers 154, 156 with the side rails 112, 114 when opened. The retention connections 224 can include transverse fingers 226, 228 which expand to retain the connection 224 within the corresponding mounting aperture 260 formed in the well 164 best seen in FIG. 3.

Referring briefly to FIGS. 3-7, the closed end portion 142, 144 of the side rails 112 and 114 are depicted as having identical, mirror-image configurations. The bodies 140 of each of the side rails 112 and 114 has an inverted U-shaped section formed of spaced side legs 158 and 160 which extend from a planar endwall 162. An interior cavity formed between the legs 158 and 160 and the endwall 162 may be hollow.

The innermost leg 160 has a lower end which extends outward from the main extent of the leg 160. At least one or a plurality of longitudinally spaced wells 164 are formed in the laterally extending portion 162 for receiving fasteners 168, rivets, etc. to fixedly secure the side rails 112 and 114 to the vehicle roof 100. A laterally outermost notch 170 is formed in the laterally extending portion of well 164 for receiving a bottom edge of the covers 154.

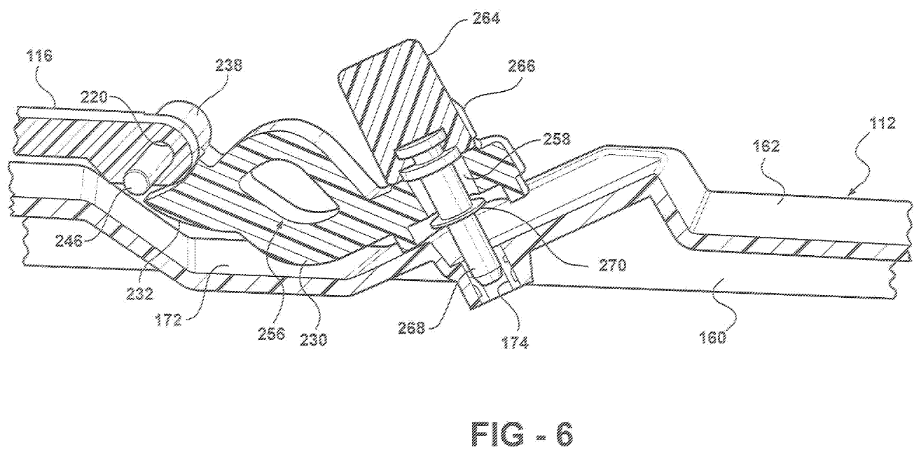

As best seen in FIG. 6, an inward extending well 172 depends from the inner surface of the endwall 162 of each body 140 into the interior of the main portion of each side rail 112 and 114. The wells 172 non-rotatably capture a nut 174 which threadingly engages a thumbwheel as described in greater detail hereafter to fix the first or front cross rail 116 in the first stowed position and to allow release of the first cross rail 116 for movement to the second laterally extending deployed position.

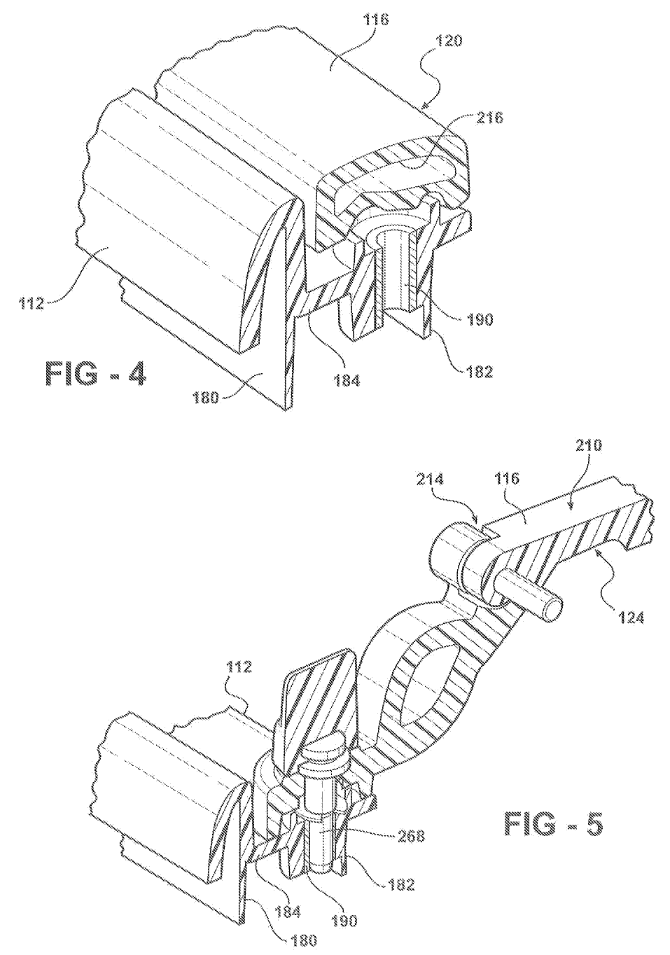

Referring now to FIGS. 4 and 5, the recessed section 148 of body 140 of the side rails 112 and 114 has a similar configuration as the closed end portions 142, 144 with spaced side legs 180 and 182 which extend from a planar endwall 184. As best seen in FIGS. 1-5, the longitudinally spaced positions 132, 134, and 136 shown by way of example for the rear cross rail 130 are defined by longitudinally spaced, pairs of laterally aligned threaded inserts 190 fixedly secured to the corresponding side rails 112 or 114, by way of example and not limitation, using ultrasonic, heat, or molded in techniques known to those skilled in the art. The innermost leg 160 of the side rail body 140 has a plurality of laterally outward extending surfaces 152 with one or more wells 164 which fit about and are joined to a fastener, such as a weld stud 168, welded to the vehicle roof 100, as best seen in FIG. 3. Similarly, a notch 170 is formed in the surface of the body 140 for receiving a lower edge of the rear cover 156.

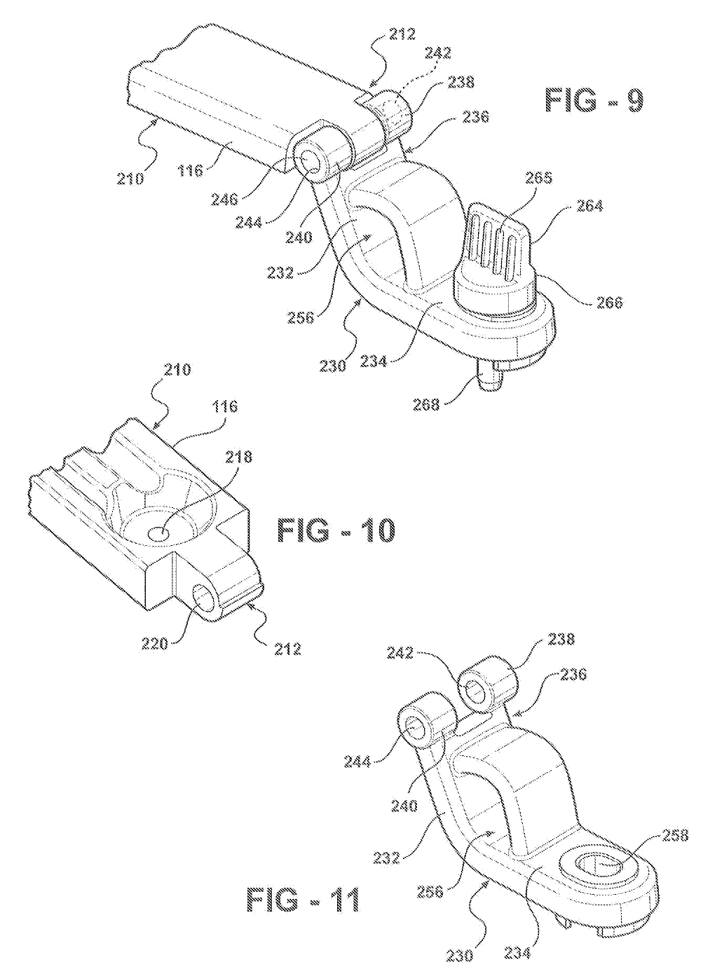

Referring now to FIGS. 2, 5, 9, 10 and 11, there is depicted construction of the first or foremost cross rail 116. The end support shown in FIGS. 5 and 9, although illustrated as being used with the front cross rail 116, will be understood to be usable also with the rear cross rail 118.

The front cross rail 116 includes a tubular member 210 having a first end 212 and an opposed second end 214. The tubular member 210 can have any exterior shape, with a typical airfoil shape illustrated for aerodynamic instructional purposes. The entire tubular member 210 may be hollow or solid, or have hollow end portions as shown for the front cross rail 116 in FIG. 4.

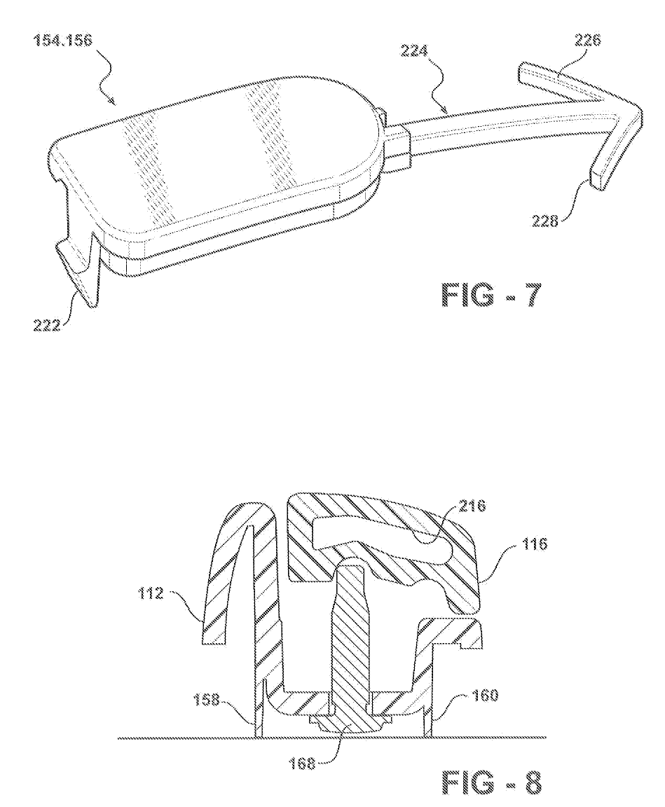

The tubular member 210 may be formed of a suitable high strength material, such as a metal, i.e., aluminum, and various plastics, fiberglass, and other composites. The ends 212 and 214 of the tubular member 210 forming the front cross rail 116 have a hollow end portion as shown in FIG. 7 for the front cross rail 116. An aperture or an elongated slot 220 is formed along one surface of the tubular member 210 in the hollow end portion spaced inward from the ends 212 and 214 for movable connection to an end support 230. As best seen in FIGS. 4, 7, and 10, the tubular member 210 can include a hollow interior channel 216 extending along at least a portion of a longitudinal length of each cross rail 116, 118. The interior channel 216 can extend along a substantial portion of the longitudinal length of the cross rails 116, 188, if desired. The hollow interior channel 216 can be formed between corresponding inlet and outlet ports 218, best seen in FIG. 10, during formation of the cross rails 116, 118 using gas-assist, injection molding techniques. These techniques can provide high strength, low weight, cross rails 116, 118 suitable for use in roof luggage racks for vehicles. The cross-sectional configuration of the cross rails 116, 118 can be configuration, by way of example and not limitation, approximately circular shaped, approximately oblong shaped, approximately elliptical shaped, aerodynamically curved, approximately rectangular shaped, approximately triangular shaped, approximately trapezoidal shaped, or contoured pursuant to finite element analysis for desired strength to weight characteristics. The gas assist channel 216 can also be of any desired cross sectional configuration. Additional tie down apertures can be formed at one or more locations longitudinally along the length of the cross rails 116, 118, if desired.

Two end supports 230 are coupled to the tubular body 210 forming the front cross rail 116. Each of the end supports 230 have essentially the same configuration and include a first member 232 having a first end 234 shaped to receive a threaded thumbwheel driven fastener 266 operably engaged with the laterally aligned threaded inserts 190 associated with the respective cross rails 116, 118 and an opposed second end 248 formed as a clevis 236 with spaced arms 238 and 240 having aligned apertures 242 and 244 which receive a pivot pin 246 used to pivotally connect the first member 232 of the end support 230 and the aperture 220 in the tubular member 210.

The second end 248 of each end support 230 includes two spaced arms 238, 240, each carrying apertures 242, 244, which fit with end 212, 214 and receive the pivot pin 246 therethrough to pivotally couple the end supports 230 to the first and second end 212, 214 of each end cross rail 116, 118 together. The pivotally interconnected ends 212, 214 of the end supports 230 provide a pivoting action to the respective cross rails 116, 118, which enables the cross rails 116, 118 to be manually moved between a low profile, stowed position aligned with the corresponding side rail 112, 114, and a high profile, deployed position extending between the side rails 112, 114 in any of the predetermined positions 124, 130, 132, 134, 136. The high profile, deployed position of each cross rail 116, 118 enables the cross rails 116, 118 to clear any crown in the roof 100 while enabling the cross rails 116, 118 to move to a low profile, stowed position, nested within a pocket or depression 150 when aligned with the associated side rail 112, 114.

The end support 230 has a first through bore 256 which acts as a bore for receiving an article tie down to secure the article to the associated crossbar 116, 118. On the opposite or second end of the associated cross rail 116, 118, the support 230 is similarly formed with a first through bore 256, and an elongated slot 258 best seen in FIG. 11. The slot 258 operably interacts with the enlarged head 264 of a fastening member, such as a thumbwheel 266. The thumbwheel 266 includes the head 264 which may have any configuration, such as the generally rectangular configuration shown in FIGS. 5, 6, and 9, or others including rounded, elliptical, etc. A shank 268 extends from the head 264. At least one retainer ring 270 best seen in FIG. 6 is mounted in a groove along the shank 264 to rotatably couple the thumbwheel 266 through the bore 258 in the support 230 and through the threaded insert 174 or 190 captured in the corresponding side rail 112, 114 to fixedly and removably attach the end support 230 at the second end of the respective cross rail 116, 118 to the corresponding side rail 112, 114, when the cross rail 116, 118 is in the deployed or second position 124, 130, 132, 134, 136. Loosening of the thumbwheel 266 and separation of the threaded end portion from the threaded insert 190 allows the thumbwheel 266 to be disengaged from the side rail 114 while still retained within the end support 230′ by the retainer ring 270 and to allow the cross rail 116, 118 to be moved or relocated to the first stowed position, also shown in FIG. 1. The thumbwheel 266 can have a finger grip surface 265 an one portion of the head 264. The head 264 may be formed of a suitable material, such as a metal or the illustrated plastic. The head 264 can be insert molded about a steel or other metal shank 268 which carries the grooves for receiving the one or more retainer rings 270.

When it is desired to deploy the rear cross rail 118, the thumbwheel is loosened until the threaded end of the shank is released from the threaded insert 174 embedded within the corresponding side rail 112, 114. The retainer ring in the end of the thumbwheel shank maintains the thumbwheel 266 associated with the cross rail 118 during movement between the stowed position 128 to one of the deployed positions 130, 132, 134, or 136. For this purpose, threaded inserts 190 are provided at opposite ends of a storage pocket or depression formed in the corresponding side rail 112, 114 for anchoring the respective cross rail 116, 118 in the stowed position using the threaded end of the shank of the thumbwheel 266.

Reverse operation is employed to release the rear cross rail from the second use or deployed position for movement back to the first stowed position before the thumbwheels are again tightened to lock the rear cross rail 118 in the first stowed position on the second side rail 114.

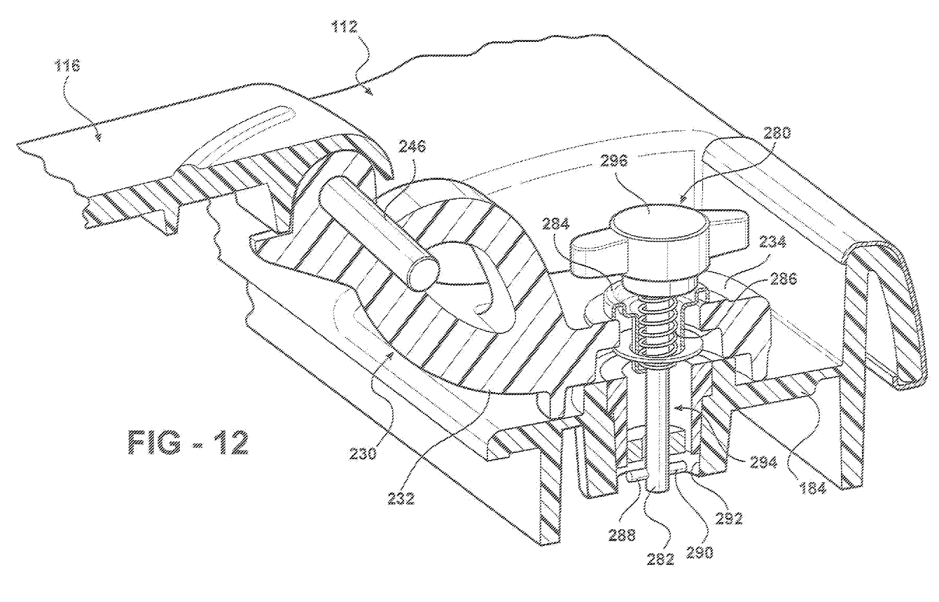

Referring now to FIG. 12, there is depicted an alternate aspect of a fastener 280 which releasably connects the end 234 of the support 230 and each cross rail, such as cross rail 116, to the first or second side rails 112 and 114. The fastener 240 is a ¼ turn fastener employing a spring biased shank 282 mounted in a head 284 seated within a slot 292 of a receptacle 294 which is ultrasonically or heat-welded or otherwise fixedly mounted in the planar endwall 184 of the side rail 112 or 114. In a locked position, the spring 286 compressably biases the end 234 of the support 230 into tight engagement with the endwall 184 of the side rail 112 and laterally extending pin ends 288 and 290 on an end of the shank 282 into engagement with the end of the receptacle 294 diametrically situated relative to the slot 292 to secure the cross rail 116 and the support 230 in a fixed position.

A two-lobe knob 96 may be depressed toward the first end 234 of the support 230 disengaging the pin ends 288 and 290 from the slot or aperture 292 in the receptacle 294. The knob 296 may then be rotated 90° or a ¼ turn.

When the knob 296 is rotated to the position shown in FIG. 12, the pin ends 288 and 290 are retracted into the slot or aperture 292 in the receptacle 294 by the spring 286 when downward force on the knob 296 is released, enabling the shank 282 move upward relative to the receptacle 294. This disengages the pin ends 288 and 290 from the receptacle 294 and enables the first end 234 carrying the fastener 280 to be pivoted upward relative to the cross rail 116 and the fixed side rail 112 to disengage the shank 282 from the receptacle 294 and enabled to the stowed position repositioning of the cross rail 116 as described above.

The fastener 280 and the receptacle 294 may be a Fairchild fastener ¼ turn stud assembly and receptacle, Part Nos. 26S98-[ ]-1DA and 26R-48-1-1-AA.

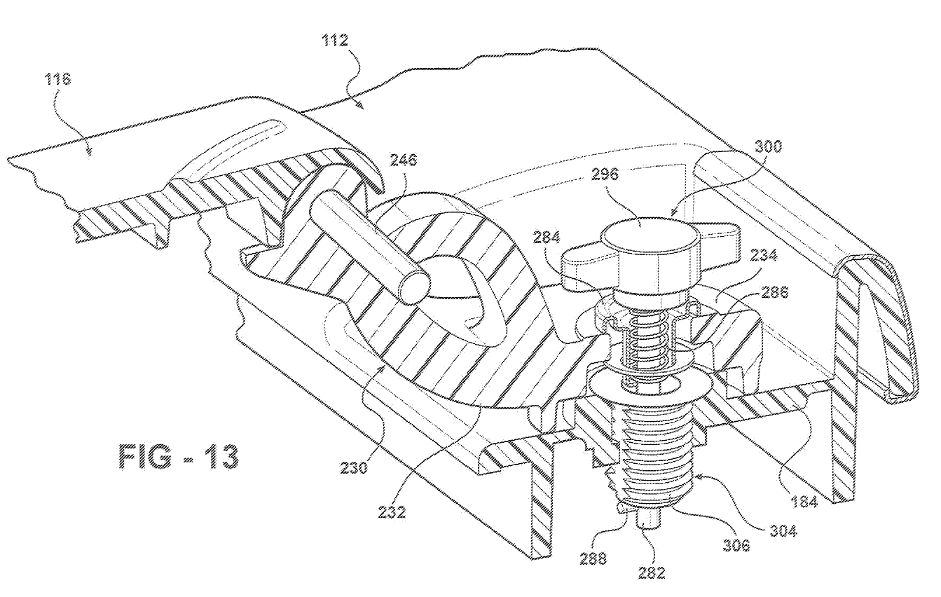

FIG. 13 depicts another aspect of a fastener 300 which may be a ¼ turn fasteners Fairchild fastener Part Nos. 26S98-[ ]-1DA, 99E10-01 and 15R10-1AC. The fastener 300 also includes a plastic, two lobe knob 296, a shank 282 having one or two transversely extending pin end, with only pin end 288 shown in FIG. 13, biased by a spring 286 in one direction relative to a housing or enlarged head 284. The operation of the fastener 300 is identical to that described above for the fastener 280.

However, in this aspect, a ¼ turn receptacle 304 is threadingly mounted by means of external threads 306 into a bore formed in the endwall 186 of the side rail 112. A keyed or flat portion 306 is formed in the threads 306 on the receptacle 304 and abuts a complimentary flat formed in the bore of the endwall 184 of the side rail 112 to prevent rotation of the receptacle 304 during movement of the fastener 300.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An article carrier for attachment to a vehicle comprising:
a first side rail and a second side rail to be located extending generally parallel to one another and spaced laterally from one another;
a first cross-rail and a second cross-rail, each cross-rail movable between a stowed position and a deployed position, wherein the stowed position of the first and second cross-rails are axially aligned with a corresponding side rail, and the deployed position of the first and second cross-rail are laterally extending between the first and second side rails; and
a manually hand/finger rotated fastener attaching each end of the first and second cross-rails to the first and second side rails in the stowed position and the deployed position.

2. The article carrier of claim 1, wherein the first and second cross-rails are removable from the first and second side rails.

3. The article carrier of claim 1, wherein the first and second cross-rails are in predetermined fixed locations when in the deployed position.

4. The article carrier of claim 1, wherein the first and second cross-rails are positionable in any one of a plurality of predetermined fixed locations axially spaced along the first and second side rails when in the deployed position.

5. The article carrier of claim 1, wherein the first and second cross-rails are in predetermined fixed locations when in the stowed position.

6. The article carrier of claim 1 further comprising:
a pivot joint located between each end of the first and second cross-rails and a central portion of the corresponding cross-rail, each pivot joint allowing the central portion of the associated cross-rail to pivot between a high profile mode when in the deployed position and a low profile mode when in the stowed position.

7. The article carrier of claim 1, wherein each of the first and second cross-rails further comprise:
a gas assist injection molded cross-rail having a hollow interior extending longitudinally along at least a portion of the cross-rail.

8. The article carrier of claim 1 further comprising:
a stanchion pivotally connected to each end of the first and second cross-rails, each stanchion supporting a corresponding one of the manually hand/finger rotated fasteners associated with each end of the cross-rails, and each stanchion pivotable between a high profile mode when the cross-rails are in the deployed position and a low profile mode when the cross-rails are in the stored position.

9. The article carrier of claim 1 further comprising:
each side rail including at least one aperture adjacent a foremost end and at least one aperture adjacent a rearmost end, each aperture for receiving a fastener for attachment of the corresponding side rail to a roof structure of a vehicle; and a snap-in, tethered cover for closing each aperture in the side rails.

10. An article carrier for attachment to a vehicle comprising:
a one-piece first side rail and a one-piece second side rail to be located extending generally parallel to one another and spaced laterally from one another;
a gas-assist, injection molded first cross-rail and a gas-assist, injection molded second cross-rail, each cross-rail movable between a stowed position and a deployed position, wherein the stowed position of the first and second cross-rails are axially aligned with a corresponding side rail, and the deployed position of the first and second cross-rail are laterally extending between the first and second side rails;
a manually hand/finger rotated fastener attaching each end of the first and second cross-rails to the first and second side rails in the stowed position and the deployed position; and
a stanchion pivotally connected to each end of the first and second cross-rails, each stanchion supporting a corresponding one of the manually hand/finger rotated fasteners associated with each end of the cross-rails, and each stanchion pivotable between a high profile mode when the cross-rails are in the deployed position and a low profile mode when the cross-rails are in the stored position.

11. The article carrier of claim 10, wherein the first and second side rails are formed of non-filled, non-abrasive nylon.

12. The article carrier of claim 10 further comprising:
a single pivot pin connecting each stanchion to a corresponding end of the cross-rails.

13. The article carrier of claim 10, wherein the first and second cross-rails are removable from the first and second side rails.

14. The article carrier of claim 10, wherein the first and second cross-rails are in predetermined fixed locations when in the deployed position.

15. The article carrier of claim 10, wherein the first and second cross-rails are positionable in any one of a plurality of predetermined fixed locations axially spaced along the first and second side rails when in the deployed position.

16. The article carrier of claim 10, wherein the first and second cross-rails are in predetermined fixed locations when in the stowed position.

17. The article carrier of claim 10 further comprising:
a pivot joint located between each stanchion located on opposite ends of the first and second cross-rails and a central portion of the corresponding cross-rail, each pivot joint allowing the central portion of the associated cross-rail to pivot between a high profile mode when the cross-rail is in the deployed position and a low profile mode when the cross-rail is in the stowed position.

18. The article carrier of claim 10, wherein each of the first and second cross-rails have a hollow interior extending longitudinally along at least a portion of the cross-rail.

19. The article carrier of claim 10 further comprising:
each side rail including at least one front end anchoring aperture and at least one rear end anchoring aperture, each aperture for receiving a fastener for attachment of the corresponding side rail to a roof structure of a vehicle; and a snap-in, tethered cover for closing each aperture in the side rails.

20. An article carrier for attachment to a vehicle comprising:
a one-piece first side rail and a one-piece second side rail to be located extending generally parallel to one another and spaced laterally from one another, the first and second side rails formed of non-filled, non-abrasive nylon;
a gas-assist, injection molded first cross-rail and a gas-assist, injection molded second cross-rail, each cross-rail removable from the side rails to be relocated between a stowed position and a deployed position, wherein the stowed position of the first and second cross-rails are axially aligned with a corresponding side rail, and the deployed position of the first and second cross-rail are laterally extending between the first and second side rails, each of the first and second cross-rails having a hollow interior extending longitudinally along at least a portion of the cross-rail, the first and second cross-rails positionable in any one of a plurality of predetermined fixed locations axially spaced along the first and second side rails when in the deployed position;
a manually hand/finger rotated fastener attaching each end of the first and second cross-rails to the first and second side rails in the stowed position and the deployed position;
a stanchion connected to each end of the first and second cross-rails, each stanchion supporting a corresponding one of the manually hand/finger rotated fasteners associated with each end of the cross-rails; and
a pivot joint located between each stanchion located on opposite ends of the first and second cross-rails and a central portion of the corresponding cross-rail, each pivot joint allowing the central portion of the associated cross-rail to pivot between a high profile mode when the cross-rail is in the deployed position and a low profile mode when the cross-rail is in the stowed position.
